(19) United States
(12) Patent Application Publication
(10) Pub. No.: US 2022/0295353 A1
(43) Pub. Date: Sep. 15, 2022

(54) METHOD AND SYSTEM FOR INTENT DRIVEN DEPLOYMENT AND MANAGEMENT OF COMMUNICATION SERVICE IN A WIRELESS COMMUNICATION SYSTEM

(71) Applicant: Samsung Electronics Co., Ltd., Suwon-si, Gyeonggi-do (KR)

(72) Inventors: Deepanshu GAUTAM, Bangalore (IN); Nishant GUPTA, Bangalore (IN)

(21) Appl. No.: 17/633,924

(22) PCT Filed: Jul. 31, 2020
(86) PCT No.: PCT/KR2020/010172

§ 371 Date: Feb. 8, 2022

(30) Foreign Application Priority Data
Aug. 8, 2019 (IN) 201941032224
May 14, 2020 (IN) 201941032224

(51) Int. Cl. H04W 28/26; H04W 4/50; H04L 41/0806

(52) U.S. Cl. CPC H04W 28/26; H04W 4/50; H04L 41/0806

(57) ABSTRACT

Various embodiments of the present disclosure disclose method and system for Intent driven deployment and management of communication service at the 3GPP network edge. The principal object of the embodiments herein is to disclose methods and systems for runtime deployment and management of Communication Service Instance(s) at the edge of the 3GPP network. Another object of the embodiment herein is to provide mechanism by which a CSI can be targeted at a particular location for better market penetration. Another object of the embodiment herein is to provide mechanism by which a CSI can be deployed with the availability criteria governing when (given time stamp) the service will be available. Another object of the embodiment herein is to ease deployment of CSI at the edge of the network creating new business opportunities for both service and edge provider.

### CROSS-REFERENCE TO RELATED APPLICATIONS

This application is a 371 of International Application No. PCT/KR2020/010172, filed Jul. 31, 2020, which claims priority to Indian Provisional Patent Application No. 201941032224, filed Aug. 8, 2019, and Indian Non-Provisional Patent Application No. 201941032224, filed May 14, 2020, the disclosures of which are herein incorporated by reference in their entirety.

### BACKGROUND

### 1. Field

The present disclosure relates to the field of Fifth Generation (5G) wireless communication networks and more particularly to deploying communication services at the 3GPP network edge in 5G communication networks.

### 2. Description of Related Art

A Fifth Generation (5G) communication network comprises a 5G Access Network (AN), 5G Core Network, and at least one User Equipment (UE) (Refer to TS 23.501). The 5G network is expected to provide optimized support for a variety of different communication services, different traffic loads, and different end user communities.

The 5G network aims at enhancing its capability to meet Key Performance Indicators (KPIs) that the emerging Vehicle-to-everything (V2X) applications require. For these advanced applications, the requirements, such as data rate, reliability, latency, communication range and speed, are made more stringent. For example, Vehicle-to-everything (V2X) services may be used by network slicing. One of the key technologies to enable network slicing is fixed mobile convergence (FMC). FMC includes wireless-to-the-everything (WTTx) and fibre-to-the-everything (FTTx). 5G seamless eMBB (Enhanced Mobile Broadband) is therefore expected to provide native support for network slicing. For optimization and resource efficiency, the 5G network will select the most appropriate 3GPP, or non-3GPP access technology for a communication service. This allows multiple access technologies to be used simultaneously for one or more services active on a UE.

Operators can use one or more network slice instances to provide communication services, which require similar network characteristics, to different vertical industries. 3GPP TS 28.530 and 28.531 define the management of network slices in 5G networks. It also defines the concept of Communication Services, which are provided using one or multiple network slices. A network slice instance (NSI) may support multiple Communication Service Instances (CSI).

Currently, there are studies undergoing in in 3GPP SA5 (TR 28.805—Study on management aspects of communication services) which deals with the provisions of management of CSI(s) running on top of NSI(s). The 3GPP also defines management entities like Network Slice Management Function (NSMF), Communication Service Management Function (CSMF) providing Network Slice Instance (NSI) and Communication Service Instance (CSI) management services respectively. Further, a study on edge is undergoing in 3GPP SA6 (3GPP TR 23.758—Study on application architecture for enabling edge applications), for specifying an application framework or an enabling layer platform to support Edge Computing in 3GPP specified networks, (e.g. discovery of edge services, authentication of the clients). The study includes the interactions between the UE and the enabling layer platform, and the interactions between the applications deployed over edge and the enabling layer platform. Further the study enables integration with the underlying 3GPP core network.

Currently, there are no procedures defined in 3GPP, or elsewhere, concerning mechanisms for deploying and managing a Communication Service at the edge of the 3GPP network.

### SUMMARY

The principal object of the embodiments herein is to disclose methods and systems for runtime deployment and management of Communication Service Instance(s) (CSIs) at the 3GPP network edge of the 5G network.

Another object of the embodiment herein is to provide mechanism by which a CSI can be targeted at a particular location for better market penetration.

Another object of the embodiment herein is to provide mechanism by which a CSI can be deployed with the availability criteria governing when the service will be available.

Accordingly the embodiments herein provide a method for deploying at least one communication service at a network edge in a 5G network, the method comprising: sending, by an Intent Driven Management Service (IDMS) Consumer, a request to a IDMS Producer for creating at least one communication service; identifying, by the IDMS Producer, the network edge to be used for the creation of the at least one communication service, based on a service availability parameter provided in the request received from the IDMS Consumer, wherein the service availability parameter comprises a time stamp representing the availability of the requested at least one communication service; and identifying, by an Network Service Management Function (NSMF), a Network Slice Instance (NSI) to be assigned to the at least one communication service, wherein the NSI comprises an application providing server functionality for the at least one communication service.

Accordingly the embodiments herein provide a method for management of at least one communication service at network edge in a 5G network, the method comprising: sending, by a Communication Service Customer (CSC), a request to a Communication Service Producer (CSP), for creating at least one Communication Service; selecting, by the CSP, a profile, wherein the profile is available at a time stamp provided in the request received from the CSC; identifying, by the CSP, the network edge to be used for the creation of the at least one Communication Service, based on the availability parameter provided in the request received from the CSC and identifying, by an NSMF, a Network Slice Instance (NSI) to be assigned to the at least one Communication Service, wherein the NSI comprises an application providing server functionality for the at least one Communication service.

Accordingly the embodiments herein provide a system for deployment and management of at least one communication service at network edge, the system comprising: a Communication Service Customer (CSC); a Communication Service Producer (CSP) communicatively coupled to the CSC, wherein the CSP is configured to: receive a request from the CSC for creating at least one Communication Service, wherein the request is in the form of one of an Intent and a transfer protocol request; select a profile, wherein the profile is available at a time stamp provided in the request from the CSC; identify a network edge to be used for the creation of the at least one Communication Service, based on the availability parameter provided in the request received from the CSC, wherein the service availability parameter comprises the time stamp representing the availability of the requested service; and send a request to NSMF to allocate resources to the CSC, wherein the NSMF is to identify a Network Slice Instance (NSI) to be assigned to the at least one Communication Service, on receiving the request from the CSP, wherein the NSI comprises an application providing server functionality for the at least one Communication service.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

This disclosure provides methods and systems for runtime deployment and management of Communication Service Instance(s) (CSIs) at the 3GPP network edge of the 5G network.

This disclosure provides mechanism by which a CSI can be targeted at a particular location for better market penetration.

This disclosure provides mechanism by which a CSI can be deployed with the availability criteria governing when the service will be available.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 illustrates a 5G network, according to embodiments as disclosed herein.;

FIG. 2 illustrates intent-driven deployment of communication service in the network edge of the 5G network, according to embodiments as disclosed herein; and

FIG. 3 illustrates deployment of communication service in the network edge of the 5G network, according to embodiments as disclosed herein.

### DETAILED DESCRIPTION

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

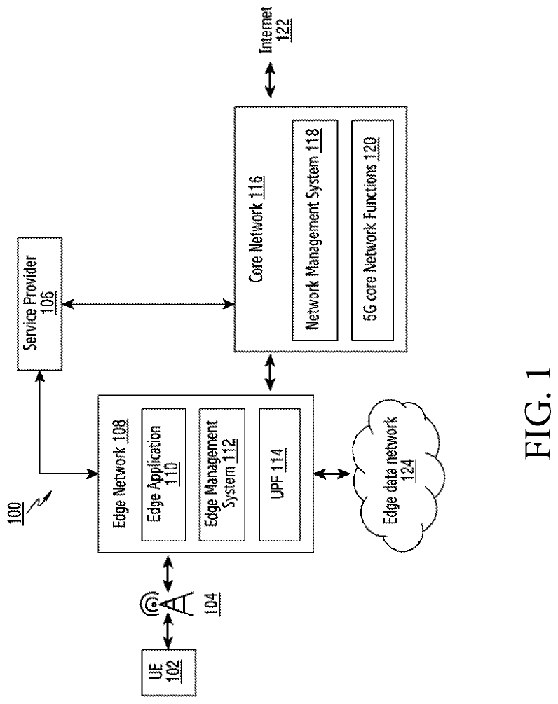

The embodiments herein achieve runtime deployment and management of Communication Service Instance(s) at the 3GPP network edge of the 5G network. Referring now to the drawings, and more particularly to FIG. 1 through FIG. 3, where similar reference characters denote corresponding features consistently throughout the figures, there are shown example embodiments.

FIG. 1 illustrates a 5G network 100, in accordance with embodiments as disclosed herein.

One of the key features of the 5G network 100 is network slicing. A network slice is a logical network that provides specific network capabilities and network characteristics. According to TS 23.501, the 5G network 100 can provide optimized support for a variety of different communication services, different traffic loads, and different end user communities. For example, the communication services using network slicing comprises Vehicle to everything (V2X) services, 5G seamless eMBB service with FMC, and massive IoT connections.

The 5G network 100 comprises at least one User Equipment (UE) 102. The at least one UE 102 may be a cellular phone (for e.g., a smart phone), a personal digital assistant (PDA), a wireless communication device, a handheld device, a laptop computer, a cordless phone, a tablet, a camera, a gaming device, a netbook, a smartbook, an ultrabook, a medical device, sensors, implant devices, wearable devices (such as smart watches, smart clothing, smart glasses, smart wrist bands, smart jewelry, and so on), an Internet of Things (IoT) device, an entertainment device, a vehicular component, smart meters, a global positioning system device, or any other suitable device that is configured to communicate via at least one of a wireless or a wired medium. The 5G network further comprises an access network, an edge network 108, service provider 106, and core network 116. The access network comprises at least one access point. The access point can be, but not limited to a base station, for e.g., gNodeB (gNB) 104. The edge network 108 comprises at least one edge application 110, Edge Management System 112 and a User Plane Function (UPF) 114.

The core network 116 comprises a Network Management System 118 and 5G Core Network Functions (NFs) 120, each coupled to one another. Network Slice Management Function (NSMF) is a part of the Network Management System (NMS) 118. The Network Slice Management Function (NSMF) is responsible for managing Network Slice(s) used for Communication Service Instances (CSIs). A wireless node may provide, for example, connectivity for or to a network (e.g., a wide area network such as Internet 122 or a cellular network) via a wired or wireless communication link.

The access network comprises at least one functional element which can enable communication between an operator 106 and a customer 102. The core network 116 comprises at least one functional element which can enable communication between operators 106 or between the UEs 102. Further, the access network can comprise one or more of Next Generation Radio Access Network (NG-RAN) and non-3GPP Access Network (AN) connecting to the core network 116.

The edge network 108 is located at the periphery of the complete, centralized network which comprises the access network and the core network 116. The Edge network 108 comprises at least one edge application 110, Edge Management System 112 and a User Plane Function (UPF) 114. The at least one Edge application 110 may comprise, for example, but not limited to, a video streaming application. The UPF 114 represents data plane evolution of a Control and User Plane Separation (CUPS) strategy. The Edge Management System 112 is responsible for overall management of edge network 108.

Edge computing enables operator and third party services to be hosted close to the UE's access point of attachment, so as to achieve an efficient service delivery through the reduced end-to-end latency and load on the transport network.

According to TS 28.530, communication services can be offered by Communication Service Providers (CSPs) 106 to Communication Service Customers (CSCs) 102. The communication services can include Business to consumer (B2C) services, business to business (B2B) services, business to household (B2H) services and business to business to everything (B2B2X) services. B2C services comprise mobile web browsing, 5G voice, Rich Communication Services, etc. B2B services comprise internet access, LAN interconnection, etc. B2H services include internet access, MBMS, VOIP, VPN, etc. B2B2X services include international roaming, RAN sharing, etc. According to embodiments described herein, various communication services, for e.g., video streaming services, are pre-configured by the Network Management System 118, so that they are available in the edge network 108 instead of being available at the core network 116. In order to facilitate the access to internet, the UPF 114 is moved to the edge network by the Network management system 118.

According to the embodiments described herein, the UE 102 can avail any Communication Service via the edge network 108 which is located between the access point 104 and the core network 116, thereby facilitating easy access to the Communication Services by a user. In other words, the request for a communication service is processed by the edge network 108 which is closer to the UE 102 than the core network 116.

According to TS 28.530 and TS 28.531, communication services can be provided by the operators to the users using one or more Network slices. A Network Slice is a logical network that provides specific network capabilities and network characteristics. A Network slice Instance (NSI) may support multiple Communication Service Instances (CSIs). According to TS 23.501, the NSI is a set of Network Function instances and the required resources which form a deployed Network Slice. The architecture of 5G network 100 can separate the User Plane (UP) functions 114 from the Control Plane (CP) functions, allowing independent scalability, evolution and flexibility deployments, for example, centralized location or distributed remote location.

The at least one UE 102 is interchangeably referred to as Communication Service Consumer (CSC) 102 throughout. The Service Provider 106 is interchangeably referred to as a Communication Service Producer and a network operator throughout.

The 5G network 100 can be configured to deploy and manage Communication Service Instance(s) at the edge of the network 100. The Communication Service Consumer (CSC) 102 can send a request to the Communication Service Producer (CSP) 106 for creation of a Communication service. The CSC 102 comprises a processor (not shown), a memory (not shown), communication interface (not shown), and a display (not shown). The request comprises plurality of parameters such as a service type parameter, a service requirement parameter, a service availability parameter, and edge identification information. The request can be in the form of a transfer protocol request, such as, but not limited to a HTTP request. The request can also be an Intent based service request. In case of the intent based service request, a UE can deliver an intent to a network operator. The intent describes the consumer's intent of deployment of a communication service at the edge of the 5G network 100. TS 23.501 defines three types of slice/service types—Enhanced Mobile Broadband (eMBB), Ultra Reliable Low Latency Communications (URLLC), Massive internet of Things (MIoT). According to TS 128.530, eMBB service type aims at supporting high data rates and high traffic densities. URLLC service type aims at supporting the requirements related to high reliability and low latency scenarios. mIoT service type aims at supporting a large number and high density of IoT devices efficiently and cost effectively.

In addition, embodiments define additional values for Service type as GEN which would be the default service type, if the CSC 102 does not provide a service type. The parameter ‘Service requirements’ provides service requirements such as number of concurrent subscribers and number of concurrent sessions. The number of concurrent subscribers defines the service requirement in terms of the total number of subscribers that the service should be able to support concurrently, which can be provided as an integer. The number of concurrent sessions defines the service requirement in terms of the total number of concurrent sessions that the service should be able to support, which can be provided as an integer. The parameter, service availability, defines availability of the service. For example, it can define time bound availability for the service. This is useful to enable the targeted availability of the service at a particular point of time or day of the week or a combination thereof.

Another important parameter is the edge identification information. A service provider may have edge network deployed at many locations. It is crucial to identify the targeted edge network where the communication service need to be deployed. The edge identification information may contain edge ID or geoLocation. The parameter edgeID will be the unique ID of the edge network which will be provided in the request. The parameter geolocation will take a form of either single latitude & longitude or a TAI.

The CSP 106 can identify and select matching service profile available in the service catalogue. The CSP 106 can select the profile based on the requested service type and requested service requirements. For example, the CSC 102 may request for video streaming. The CSP 106 can select the profile which can be available at a time stamp provided in the request from the CSC 102. The CSP 106 can identify the edge network 108 to be used, based on the information provided in the request. The CSP 106 can convert the service requirements into the resource facing requirements and can send the request to the Network Slice Management Function (NSMF) in the NMS 118 to allocate the required resources (Refer clause 7.2 of TS 28.531).

The Network Slice Management Function (NSMF) can identify the appropriate resources, for example, Network Slice Instances (NSIs), to be assigned to the communication service. The NSMF can allocate resources to be assigned to the communication service. The NSMF can allocate resource response, i.e., the NSI and its constituent Network Slice Subnet Instance (NSSI) to the CSP 106. The NSMF can indicate successful allocation of NSI/NSSI to the CSP 106.

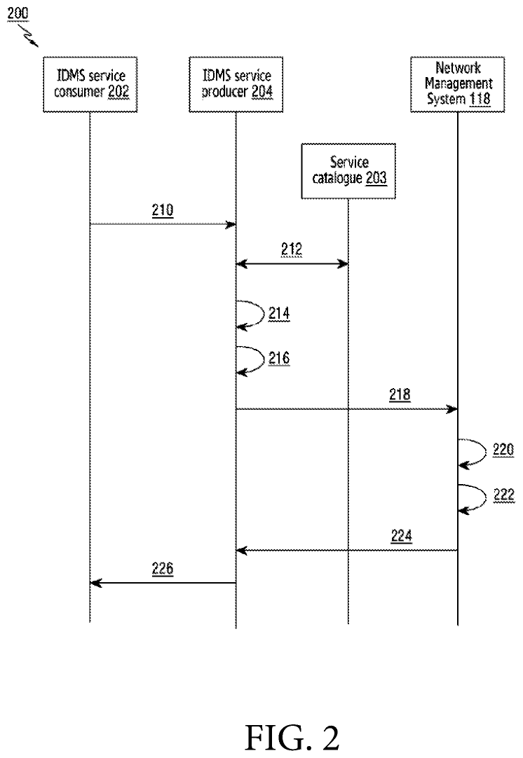

FIG. 2 illustrates intent-driven deployment of communication service in the network edge of the 5G network, according to embodiments as disclosed herein. At step 210, an Intent Driven Management Service (IDMS) service consumer 202 delivers an intent to the IDMS producer 204. The intent describes the consumer's intent of deployment of a communication service at the edge of the 5G network 100. The format of the intent is depicted in Table 1.

TABLE 1

| Intent | IntentDrivenAction | IntentDrivenObject |
|---|---|---|
| CSIatEdge | CSIatEdgeDeployment | CSIatEdge{Service type, service |
| Intent | | requirement, service availability, |
| | | edge identification information} |

On receiving the CSlatEdge intent, the IDMS Producer 204 executes the following management tasks. At step 212, the IDMS producer 204 identifies and selects the matching service profile available in the service catalogue 203. The network management system 118 configures the service catalogue during service creation. The IDMS producer 204 can access the service catalogue. The service catalogue comprises all the available services, time duration of the availability of the services, and the like. The IDMS producer 204 can be configured to find the matching service from the service catalogue.

The IDMS producer 204 can select a profile which supports URLLC service type. The IDMS producer 304 can select a profile which can be available as per the service availability requirements provided in the request from the IDMS consumer 302. TS 23.501 defines three types of slice/service types (eMBB, URLLC, MIoT) and the service type parameter can have any of the three defined values, i.e., eMBB, URLLC, or MIoT. According to TS 28.530, eMBB service type aims at supporting high data rates and high traffic densities. URLLC service type aims at supporting the requirements related to high reliability and low latency scenarios. mIoT service type aims at supporting a large number and high density of IoT devices efficiently and cost effectively.

The parameter ‘Service requirements’ provides service requirements such as number of concurrent subscribers and number of concurrent sessions. The number of concurrent subscribers defines the service requirement in terms of the total number of subscribers that the service should be able to support concurrently, which can be provided as an integer. The number of concurrent sessions defines the service requirement in terms of the total number of concurrent sessions that the service should be able to support, which can be provided as an integer.

The parameter, service availability, defines availability of the service. For example, it can define time bound availability for the service. This is useful to enable the targeted availability of the service at a particular point of time or day of the week or a combination thereof. The service availability parameter is provided in the request sent by the IDMS consumer 302 in the form of a time stamp. The time stamp indicates that a particular service requested by the IDMS consumer 302 can be made available by the IDMS producer 304 during the time period as shown below. The time stamp can be in the form of, but not limited to, yyyy-MM-dd or HH:mm:ss. The time stamp can be defined as follows: Allowed Values: <from>{<timeStamp>}−<to>{<timeStamp>}.

Another important parameter is the edge identification information. A service provider may have edge network deployed at many locations. It is crucial to identify the targeted edge network where the communication service need to be deployed. The edge identification information may contain edge ID or geoLocation. The parameter edgeID will be the unique ID of the edge network which will be provided in the request. The IDMS consumer 202 may obtain this ID and geographic area mapping beforehand when establishing a contract with the service provider or by a different offline/online method. The parameter geolocation will take a form of either single latitude & longitude or a TAI.

At step 214, the IDMS producer 204 identifies the edge network to be used based on the information provided in the request. Accordingly, the IDMS Producer 204 identifies the edge network 108 to be used for the service requested by the IDMS consumer 202. The location of the various edge network may be stored by a database (not shown) coupled to the IDMS Producer 204. At step 216, the IDMS producer 204 converts the service requirements into resource facing requirements. In other words, the IDMS producer 204 forms requirements for the underlying Network Slice Instance/Network Slice Subnet Instance (NSI/NSSI) to satisfy the service requirements. At step 218, the IDMS producer 204 sends the request to NSMF which is a part of the Network Management System (NMS) 118 to allocate the required resources to be assigned to the communication service (clause 7.2 of TS 28.531).

At step 220, the NSMF identifies the appropriate resources, for example, Network Service Instance (NSI), to be assigned to the IDMS service. The NSI shall be able to support the required service requirement, for example, lm subscriber. In addition to the required 5GS network functions, for example, User Plane Function (UPF), the NSI shall contain the application providing server functionality for the required service, for example, video streaming server functionality for an ultra-low latency video streaming service. At step 222, the NSMF then allocates NSI and its constituent NSSI (as per clause 7.2 of TS 28.531). The required configuration and provisioning of constituent NFs and the application server functionality will be performed in this step. At step 224, the NSMF indicates successfully allocation of the NSI/NSSI to the IDMS producer 204. At step 226, the IDMS producer 204 indicates successful creation of the CSI at the edge to the IDMS consumer 202.

The various actions in method 200 may be performed in the order presented, in a different order or simultaneously. Further, in some embodiments, some actions listed in FIG. 2 may be omitted.

Embodiments herein provide a mechanism to deploy and manage communication service instances at the edge of the 3GPP network. A communication service customer will be able to request for the deployment of a communication service at the 3GPP network edge at a particular location.

Embodiments herein provide two mechanisms to initiate the request a) using Intent based service request and b) using communication service request.

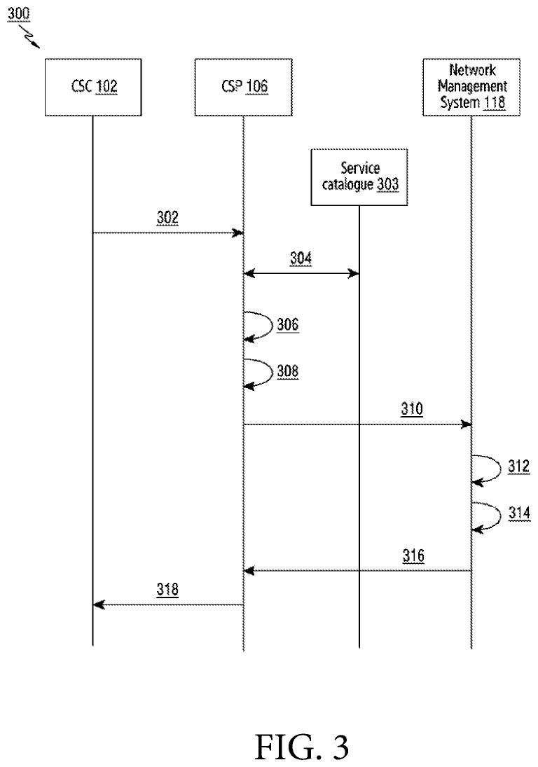

FIG. 3 illustrates deployment of communication service in the network edge of the 5G network 100, according to embodiments as disclosed herein. At step 302, a Communication Service Consumer (CSC) 102 sends a request to the Communication Service Producer (CSP) 106 for Communication Service Creation. The request comprises a service type parameter, a service requirement parameter, a service availability parameter, and edge identification information. The request can be in the form of a transfer protocol request such as, but not limited to a HTTP request. TS 23.501 defines three types of slice/service types (eMBB, URLLC, MIoT) and the service type parameter can have any of the three defined values, i.e., eMBB, URLLC, or MIoT. According to TS 28.530, eMBB service type aims at supporting high data rates and high traffic densities. URLLC service type aims at supporting the requirements related to high reliability and low latency scenarios. mIoT service type aims at supporting a large number and high density of IoT devices efficiently and cost effectively.

In addition, embodiments define additional values for Service type as GEN which would be the default service type, if the CSC 102 does not provide a service type. The parameter ‘Service requirements’ provides service requirements such as number of concurrent subscribers and number of concurrent sessions. The number of concurrent subscribers defines the service requirement in terms of the total number of subscribers that the service should be able to support concurrently, which can be provided as an integer. The number of concurrent sessions defines the service requirement in terms of the total number of concurrent sessions that the service should be able to support, which can be provided as an integer. The parameter, service availability, defines availability of the service. For example, it can define time bound availability for the service. This is useful to enable the targeted availability of the service at a particular point of time or day of the week or a combination thereof. Another important parameter is the edge identification information. A service provider may have edge network deployed at many locations. It is crucial to identify the targeted edge network where the communication service need to be deployed. The edge identification information may contain edge ID or geoLocation. The parameter edgeID will be the unique ID of the edge network which will be provided in the request. The CSC 102 may get this ID and geographic area mapping beforehand when establishing a contract with the service provider or by a different offline/online method. The parameter geolocation will take a form of either single latitude & longitude or a TAI.

At step 304, on the CSC 102 sending a request to the CSP 106 for Communication Service Creation, the CSP 106 identifies and selects the matching service profile available in the service catalogue 303. The network management system 118 configures the service catalogue 303 during service creation. The CSP 106 can be configured to access the service catalogue 303. The service catalogue 303 comprises all the available services, duration of the availability of the services, and the like. The available services can be, for example, but not limited to, video streaming services. The CSP 106 selects the profile based on the requested service type and requested service requirements. Apart from considering the requested service type and requested service requirements, the CSP 106 selects the profile based on the service availability parameter. The service availability parameter is provided in the request sent by the CSC 102 in the form of a time stamp. The time stamp can be defined as follows: Allowed Values: <from>{<timeStamp>}−<to>{<timeStamp>}. The time stamp denotes that a particular service requested by thee CSC 102 can be made available by the CSP 106 during the time period as shown above by the allowed values. The time stamp can be in the form of, but not limited to, yyyy-MM-dd and HH:mm:ss.

At step 306, the CSP 106 identifies the edge network 108 to be used, based on the information provided in the request. Accordingly, the CSP 106 identifies the edge network 108 to be used for the service requested by the CSC 102. The location of the of the various edge network may be stored by a database (not shown) coupled to the CSP 106. At step 308, the CSP 106 converts the service requirements into the resource facing requirements. In other words, the CSP 106 forms requirements for the underlying Network Slice Instance/Network Slice Subnet Instance (NSI/NSSI) to satisfy the service requirements. At step 310, the CSP 106 sends the request to Network Slice Management Function (NSMF) which is a part of a Network Management System 118 to allocate the required resources to be assigned to the communication service (clause 7.2 of TS 28.531).

At step 312, the NSMF identifies the appropriate resources, for example, Network Slice Instance (NSI), to be assigned to the communication service. The NSI can support the required service requirement, for example, lm subscriber. In addition to the required 5GS network functions, for example, User Plane Function (UPF) 114, the NSI shall contain the application that is providing server functionality for the required service, for example, video streaming server functionality for a ultra low latency video streaming service.

At steps 314 and 316, the NSMF allocates NSI and its constituent NSSI (as per clause 7.2 of TS 28.531). The required configuration and provisioning of constituent NFs and the application server functionality will be performed in this step. The NSMF indicates successful allocation of NSI/NSSI to the CSP 106. At step 318, the CSP 106 indicates successful creation of the CSI at the edge network 108.

The various actions in methods 300 may be performed in the order presented, in a different order or simultaneously. Further, in some embodiments, some actions listed in FIG. 3 may be omitted.

Embodiments herein provide mechanism to deploy and manage Communication Service Instance at the edge of the 3GPP network. A communication service customer will be able to request for the deployment of a communication service at the 3GPP network edge in a particular location. Embodiments herein provide two mechanisms to initiate the request a) using communication service request b) using Intent based service request.

The embodiments disclosed herein can be implemented through at least one software program running on at least one hardware device and performing network management functions to control the elements. The elements shown in FIG. 1 can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

1. A method for deploying at least one communication service at a network edge in a 5G network, the method comprising:
sending, by an Intent Driven Management Service (IDMS) Consumer, a request to a IDMS Producer for creating at least one communication service;
identifying, by the IDMS Producer, the network edge to be used for the creation of the at least one communication service, based on a service availability parameter provided in the request received from the IDMS Consumer, wherein the service availability parameter comprises a time stamp representing the availability of the requested at least one communication service; and
identifying, by an Network Service Management Function (NSMF), a Network Slice Instance (NSI) to be assigned to the at least one communication service, wherein the NSI comprises an application providing server functionality for the at least one communication service.

2. The method as claimed in claim 1, wherein the time stamp representing the availability of the requested at least one communication service indicates a time duration in which the requested at least one communication service is made available by the IDMS Producer.

3. The method as claimed in claim 1, wherein the intent comprises value of the intent, value of intent driven action, and value of intent driven object.

4. The method, as claimed in claim 1, wherein the value of the intent is CSIatEdge Intent.

5. The method, as claimed in claim 3, wherein the value of intent driven action is CSIatEdge Deployment.

6. The method, as claimed in claim 3, wherein the value of the intent driven object is CSIatEdge {Service type, service requirement, service availability, and edge identification information}.

7. The method as claimed in claim 1, wherein selecting, by the IDMS Producer, a matching service profile available in a service catalogue as per service requirements provided in the request from the IDMS Consumer for creating at least one communication service.

8. The method as claimed in claim 7 comprising, converting, by the IDMS Producer, the service requirements into resource requirements for underlying Network Slice Instance/Network Slice Subnet Instances (NSI/NSSI) to satisfy the service requirements.

9. The method as claimed in claim 1 comprising allocating, by the NSMF, Network Slice Instance/Network Slice Subnet Instance (NSI/NSSI), on identifying the network edge to be used for the creation of the at least one communication service, wherein allocating the NSI/NSSI comprises allocating one or more of required configuration, provisioning of Network Functions (NFs), and application server functionality.

10. The method as claimed in claim 1 further comprising indicating, by the NSMF, successful allocation of NSI/NSSI to the IDMS Producer.

11. The method as claimed in claim 1 further comprising indicating, by the IDMS Producer, successful creation of the at least one communication service at the network edge, on successful allocation of NSI/NSSI.

12. The method as claimed in claim 6, wherein the edge identification information comprises at least one parameter for identifying targeted edge network for deploying the at least one communication service, wherein the at least one parameter comprises one or more of “edgeID” and “geoLocation”.

13. A system for deployment and management of at least one communication service at network edge, the system comprising:
a Communication Service Customer (CSC);
a Communication Service Producer (CSP) communicatively coupled to the CSC, wherein the CSP is configured to:
receive a request from the CSC for creating at least one Communication Service, wherein the request is in the form of one of an Intent and a transfer protocol request;
select a profile, wherein the profile is available at a time stamp provided in the request from the CSC;
identify a network edge to be used for the creation of the at least one Communication Service, based on the availability parameter provided in the request received from the CSC, wherein the service availability parameter comprises the time stamp representing the availability of the requested service; and
send a request to NSMF to allocate resources to the CSC, wherein the NSMF is to identify a Network Slice Instance (NSI) to be assigned to the at least one Communication Service, on receiving the request from the CSP, wherein the NSI comprises an application providing server functionality for the at least one Communication service.

14. The system as claimed in 13, wherein the time stamp representing the availability of the requested at least one communication service indicates a time duration in which the requested at least one communication service is made available by the CSP.

15. The system as claimed in claim 13, wherein the intent comprises value of the intent, value of intent driven action, and value of intent driven object, wherein the value of the intent is CSIatEdge Intent, wherein the value of intent driven action is CSIatEdgeDeployment, and wherein the value of intent driven object is CSIatEdge {Service type, service requirement, service availability, edge identification information}.
